(19) United States
(12) Patent Application Publication
(10) Pub. No.: US 2003/0154111 A1
(43) Pub. Date: Aug. 14, 2003

(54) Automotive collision repair claims management method and system

(76) Inventors: Daniel Arthur Dutra, Cotati, CA (US); Nigel Glass, Luton (GB); Douglas Matthew Kelly, Kennett Square, PA (US); Catherine A. Marchand, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/109,911

(22) Filed: Mar. 28, 2002

Related U.S. Application Data
(60) Provisional application No. 60/280,547, filed on Mar. 30, 2001.

(51) Int. Cl. G06F 17/60; G06G 7/00; G06F 17/00

(52) U.S. Cl. 705/4; 705/400

(57) ABSTRACT

A method and system for managing the collision repair process after a vehicle has been damaged in a collision. The system includes a single point of contact that handles the auto insurance claims and manages the repair work to improve the entire claims handling process, from the initial claim to the final repair work.

### CROSS-REFERENCE TO RELATED APPLICATION

This application claims priority under 35 U.S.C. §119 from U.S. Provisional Application Ser. No. 60/280,547 (filed Mar. 30, 2001), which is incorporated by reference herein for all purposes as if fully set forth.

### APPENDIX

An appendix containing the presently preferred computer program listing is attached hereto on a compact disc, which is hereby incorporated by reference herein for all purposes as if fully set forth. The appendix contains material which is subject to copyright protection. The copyright owner has no objection to the reproduction by anyone of this appendix as it appears in the Patent and Trademark Office files or records, but otherwise reserves all copyright whatsoever.

### BACKGROUND OF THE INVENTION

1. Field of the Invention

This invention relates to a method and system for managing the entire collision repair process, from an initial insurance claim through final repair work. More particularly, this invention, which is referred to hereinafter as CollisionMD (CMD), is a comprehensive managed care solution for auto body repairs. It constitutes a single point of contact in the collision repair process, orchestrating it from the time of the accident back to the return of the vehicle to its owner. It facilitates and makes more efficient all of the interactions among the vehicle owner, insurance carrier, body shop and other service and parts providers.

2. Description of the Problem

The auto body repair industry is highly inefficient, from accident through insurance claim and repair. Although some gains have been made in the last several years by insurance companies through implementation of more sophisticated methods and systems for processing insurance claims and estimating costs for repairing vehicles damaged in a collision, as for example as taught in U.S. Pat. Nos. 5,950,169, 5,504,674, and 5,432,904, insurance companies are still anxious to lower costs and improve the vehicle owner's experience. Body shops are also anxious to shorten the claims management cycle and improve inefficiencies in the claims management and collision repair process.

The inefficiencies in the system are mainly caused by:

1. Interactions between the insurance companies and body shops are steeped in mutual distrust.

2. Fragmentation and excess capacity in the body shop industry coupled with poor management at the shop level.

3. Inefficient and costly insurance claims management systems.

Accordingly, there is a need for a comprehensive system and method for managing the entire collision repair process, from an initial insurance claim through final repair work. Such a system would preferably have a common user interface to access the various administrative steps and calculation tools. It would also be advantageous to have a centralized datafile containing all data relevant to a claim that would eliminate the need for separate paper files or datafiles and the need for wasteful manual reentry of existing data.

### SUMMARY OF THE INVENTION

This invention is therefore directed to a method and system for managing the entire automobile collision repair process, from an initial insurance claim through final repair work that eliminates or avoids the foregoing problems. More particularly, this invention, which is also referred to herein as CollisionMD (CMD), is a comprehensive managed care solution for auto body repairs. CMD provides a single point of contact for all participants in the collision repair value chain, and orchestrates the repair work from the time of the accident until the vehicle is returned to its owner. Thereby, it facilitates and makes more efficient all of the interactions among the vehicle owner, insurance carrier, body shop and other service and parts providers. CMD creates value in four ways:

1. Streamlining and standardizing the claims management process.

2. Optimizing the flow of repairable vehicles into a network of high-performing, specialized body shops

3. Leveraging scale economies in procurement for body shops.

4. Delivering a higher quality experience for vehicle owners from the accident to return of their repaired vehicles, due in part to shorter cycle times, higher work quality, and not being caught in the middle of insurance company and body shop squabbles.

CMD also provides interactive communications between all parties involved in the collision repair process through a common user interface, e.g., via internet or wide area network (WAN). It acts as a hub and directs the parties to standardized cost estimating systems and parts procurement systems thus setting standardized payments for repair facilities for labor, paint, and parts; and also directs work to various body shops that can handle the work, thus eliminating delays and lost time in the insurance claim settlement process and performance of actual repair work.

According to one aspect of the invention, a CMD method is provided for managing an auto collision repair process, from an initial claim to final repair work. The claimed method comprises:

(a) providing a communication network between at least the insurance companies, third party assistance providers, and body shops;

(b) sending an auto repair insurance claim to the communication network;

(c) allocating repair work to the body shop that will perform the auto repair;

(d) sending an auto repair insurance estimate through the communication network;

(e) processing the insurance claim and generating data to satisfy claim;

(f) invoicing the insurance company for the repair work completed;

(g) sending the processed payment to the body shop that performed the auto repair work.

According to another aspect of the invention, a CMD system is provided for managing an auto collision repair process, from an initial claim to final repair work. The claimed system comprises:

(a) a remote computer for entering and processing data related to an auto repair insurance claim;

(b) a network having a communication server capable of communicating with said remote computer;

(c) an insurance claim datafile generated at said remote computer, wherein the entire datafile is transferable over the network;

(d) a common user interface allowing access of the datafile by insurance companies, third party assistance providers, body shops, claims adjusters and possibly others;

(e) software to process a claim to satisfy the claim and manage the repair work at a body shop.

In the preferred embodiments of both the method and system, the repair work is allocated into a body shop network comprised of a group of high-performing specialized body shops, allowing the method and system to target the deployment of collision repairs and optimize the work flow and the efficiency of the entire collision repair process.

All key participants in the collision repair industry will be able to benefit from CMD becoming the single point of contact for the industry. Most preferably, CMD will provide a reduction in the total claims and claims management costs for insurance carriers. CMD may also help collision repair shops optimize their operations. CMD may also improve the claims experience for vehicle owners by reducing the cycle time for repairs and claims management, and improving the quality of the repair through shop network training, access to process improvement tools, and specialization.

### BRIEF DESCRIPTION OF THE DRAWINGS

FIG. 1 shows the prior art.

FIGS. 2 and 3 (which is divided into 3A and 3B) are general flow diagrams illustrating the overall CMD process, as presently preferred.

FIG. 4 (which is divided into 4A, 4B and 4C) is general flow diagram of a subset of FIG. 3 which shows only the estimating and invoicing aspect of the basic version of the CMD process.

### DETAILED DESCRIPTION OF THE PREFERRED EMBODIMENTS

Process for Body Shops

CollisionMD provides a virtual network of body shops, linked by (e.g., Internet) information systems, that can capture value by eliminating inefficiencies in the current auto repair process. This is primarily achieved by streaming standardized repairs, preferably through a select network of shops and improving the many processes on the shop floor, and also through improved relationships with insurance companies, negotiated by CMD on behalf of both parties.

CMD preferably establishes and manages a network of high quality, reputable, independent body shops. Each body shop will, over time, be encouraged to specialize along make and model, type and/or severity of collision based on the skill and experience of its technicians and the quality of its equipment and facilities. This specialization based on a steady stream of consistent work will help drive significant efficiencies in the repair process at the shop level.

Payment for repairs is also managed under the CMD process. Payment is usually divided into two components, payment for parts and payment for labor. The parts component is usually based on commercial pricing. The labor payment component, however, is preferably based on a pre-negotiated menu of prices (“Payment Grid”) within CMD, categorized by collision severity, make, model, year and other factors. Repairs falling in each category will be reimbursed at an average repair cost per category rather than an individual estimate. Over time, body shops will be able to increase the amount of work they receive by sharing the efficiencies gained through participation in the program. This will be accomplished through a discount on the body of repairs at the body shop in exchange for increased, streamed volume. For the body shop, the average revenue per repair could decrease but the costs of that repair will also decrease and the shop will be provided a higher volume of desirable repair work. CMD also provides a basket of services and process improvement tools to body shops that will centralize and professionalize non-core overhead functions. Aggressive marketing by CMD both to vehicle owners and insurance carriers will preferably increase the volume channeled by CMD, increasing the repairs directed within the network and allowing specialization to increase.

Over time, it is envisioned that CMD will work with the body shops to implement shop management and decision support tools.

CMD Software

CollisionMD (CMD) provides interactive communications between all parties involved in the collision repair process using controlled procedures. This controlled process will be handled through the use of the CMD “Payment Grid” and parts procedures through the CMD Hub thus setting standardized payments for repair facilities, for labor, paint and parts. The core technology is designed to be provided via the Internet. The processes associated with the administration of first notice of loss, triage (as explained below), allocation of work to shop network, processing of automobile damage repair estimates, payment grid, automobile damage reports, insurance claims administration and payment to vendors, repair facilities and other third party participants, including payment facilitators, are central to the CollisionMD process. The design of the solution(s) requires access to data from disparate database(s) along with the necessary architecture for internal (Intranet) and external networks including the Internet with access to the world wide web, as will be appreciated by persons skilled in the art.

The overall functionality of the software includes:

Inter-active communication between parties

Management and control of the entire process (cradle to grave scenario)

Data collation and statistical reporting

Operation of CMD payment grid

Allocation/re-allocation of repair order to appropriate repairers

Consolidation of invoicing data

Processing of consolidated re-charges and resultant disbursements

Courtesy/replacement vehicle management.

The parties having access to the CMD software include (potentially):

Insurance carrier*

Policyholder

Repairer*

Shop Network Administrator*

CMD Hub Administrator*

Broker

Paint Distributor

Parts Suppliers

Consulting engineers*

Helpline

Third party assistance provider (TPA)*

Other

The parties with asterisks (*), at least, should have mandatory access to the CMD software.

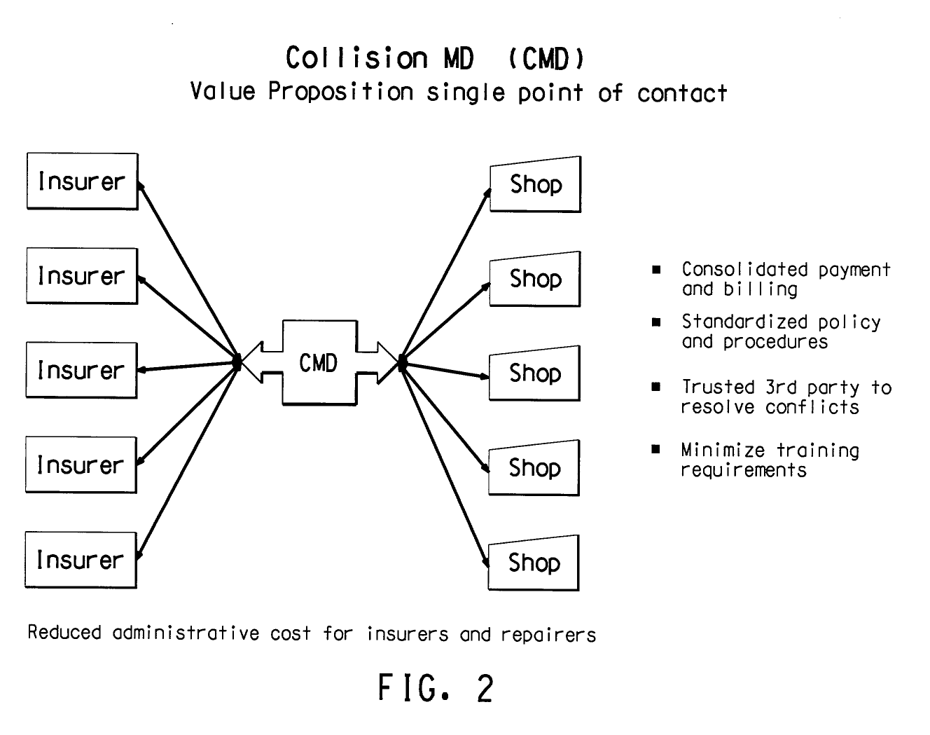

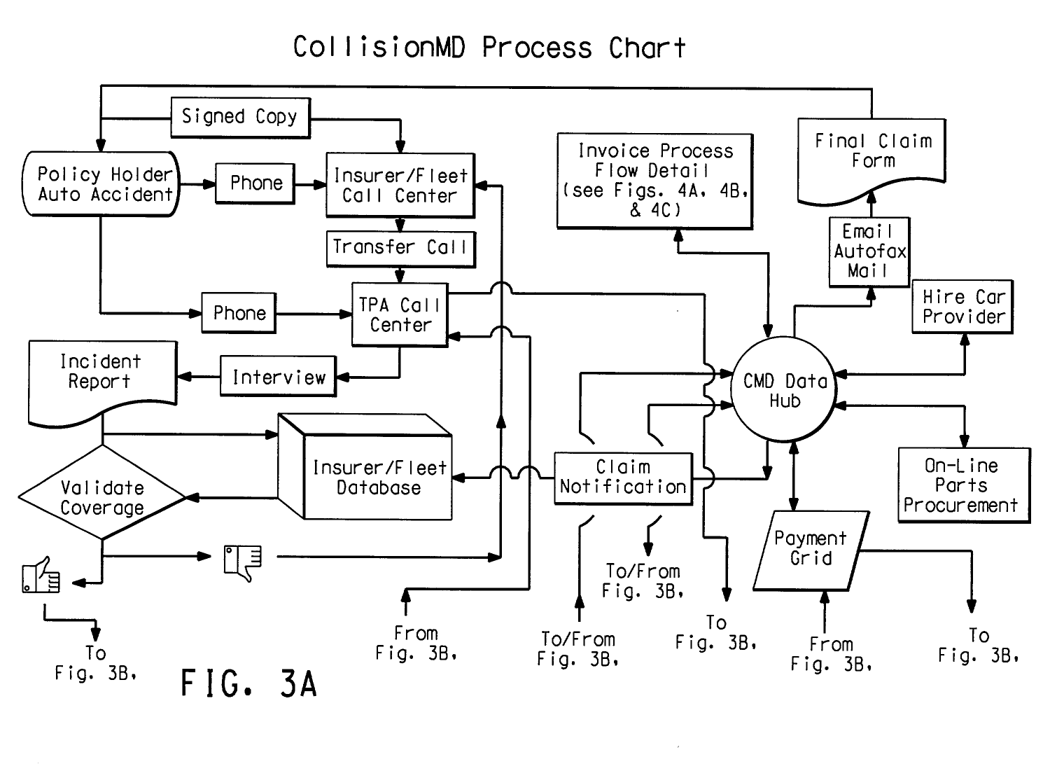

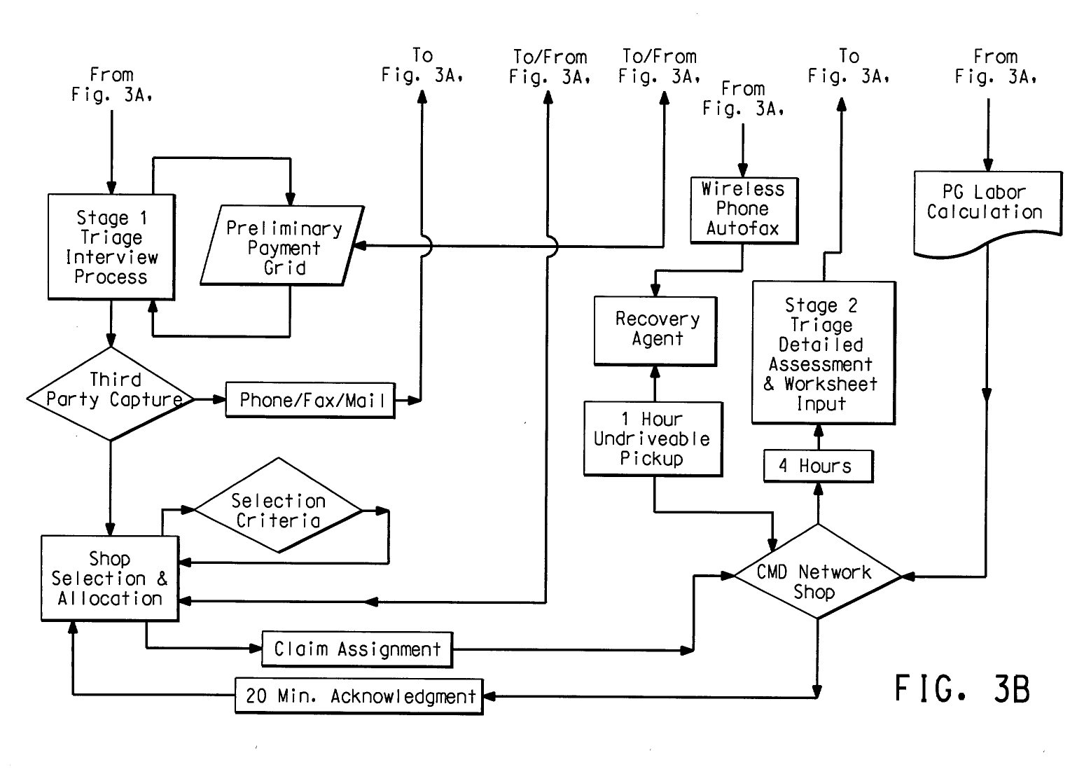

The overall CMD process, as presently preferred, can be seen in FIGS. 2, 3A and 3B.

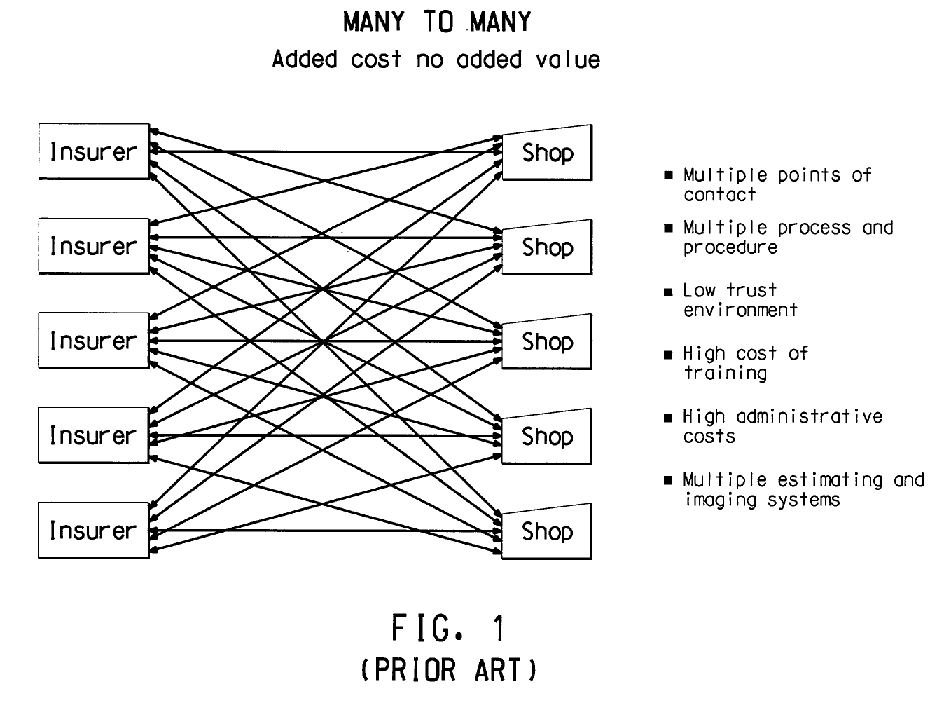

The differences between CMD process and the prior art can be seen in FIG. 1. As shown in FIG. 1, the prior art methods and systems used for processing insurance claims and estimating costs for repairing vehicles damaged in a collision involve multiple points of contacts, multiple process and procedures, and multiple estimating systems. The CMD process and system, on the other hand, as shown in FIG. 2, acts as a hub and directs the parties to standardized cost estimating systems and parts procurement systems thus setting standardized payments for repair facilities for labor, paint, and parts; and also directs work to various body shops that can handle the work, thus eliminating delays and lost time in the insurance claim settlement process and performance of actual repair work.

First Embodiment—The Basic CMD Process

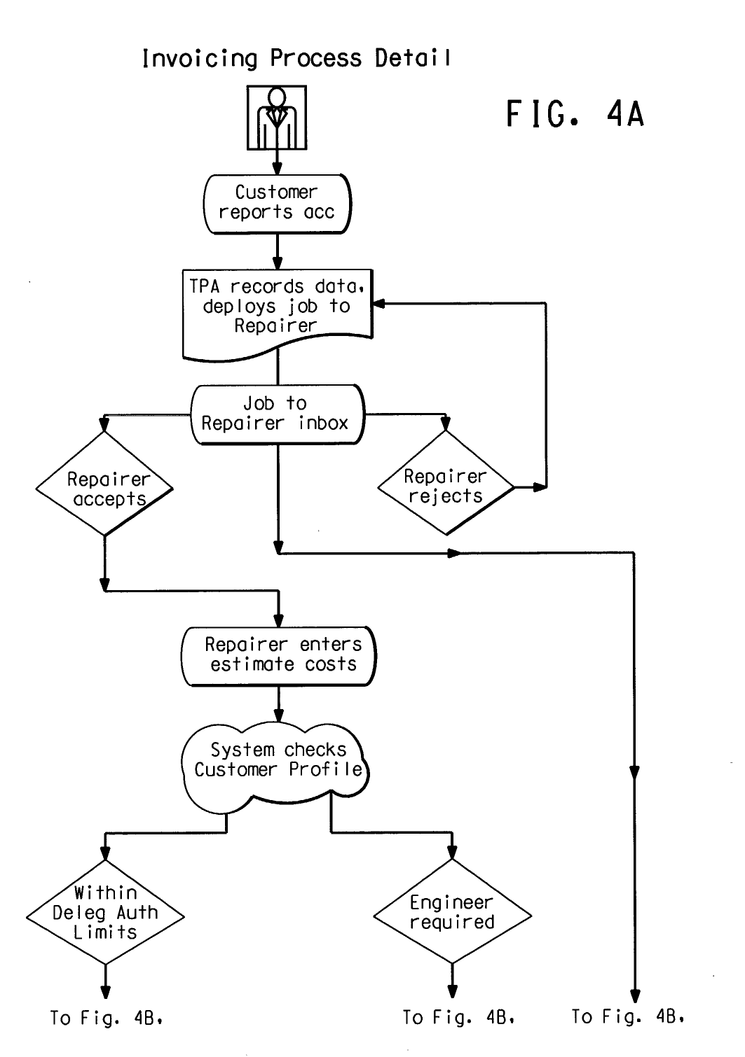

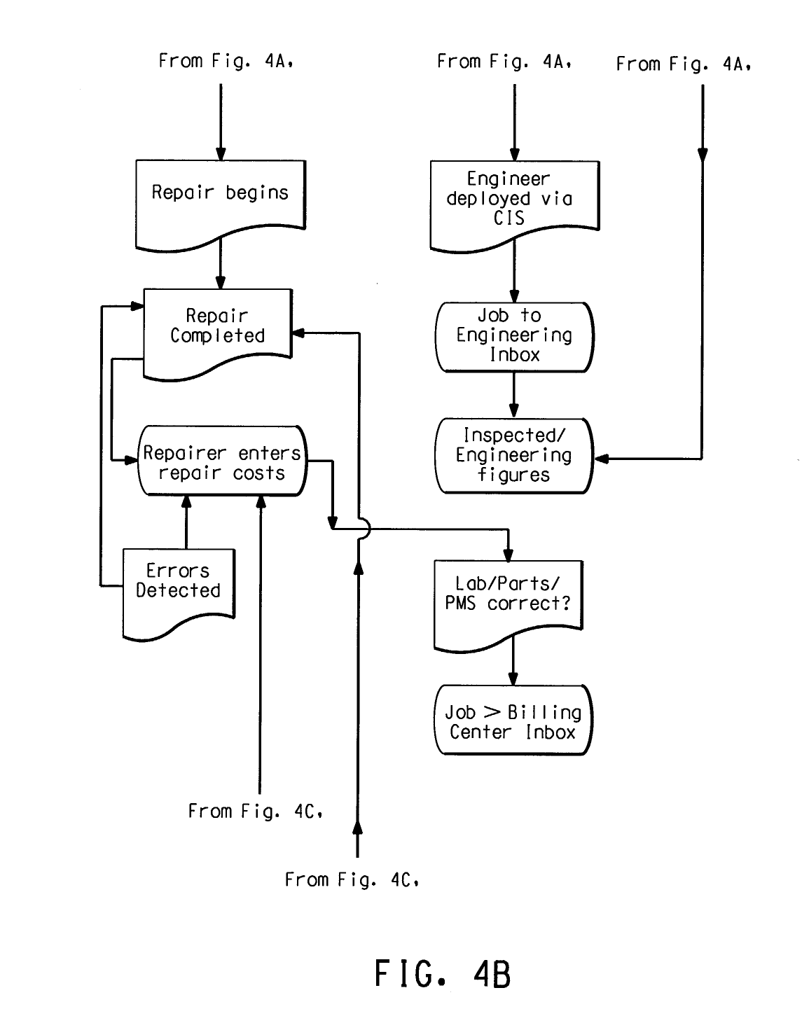

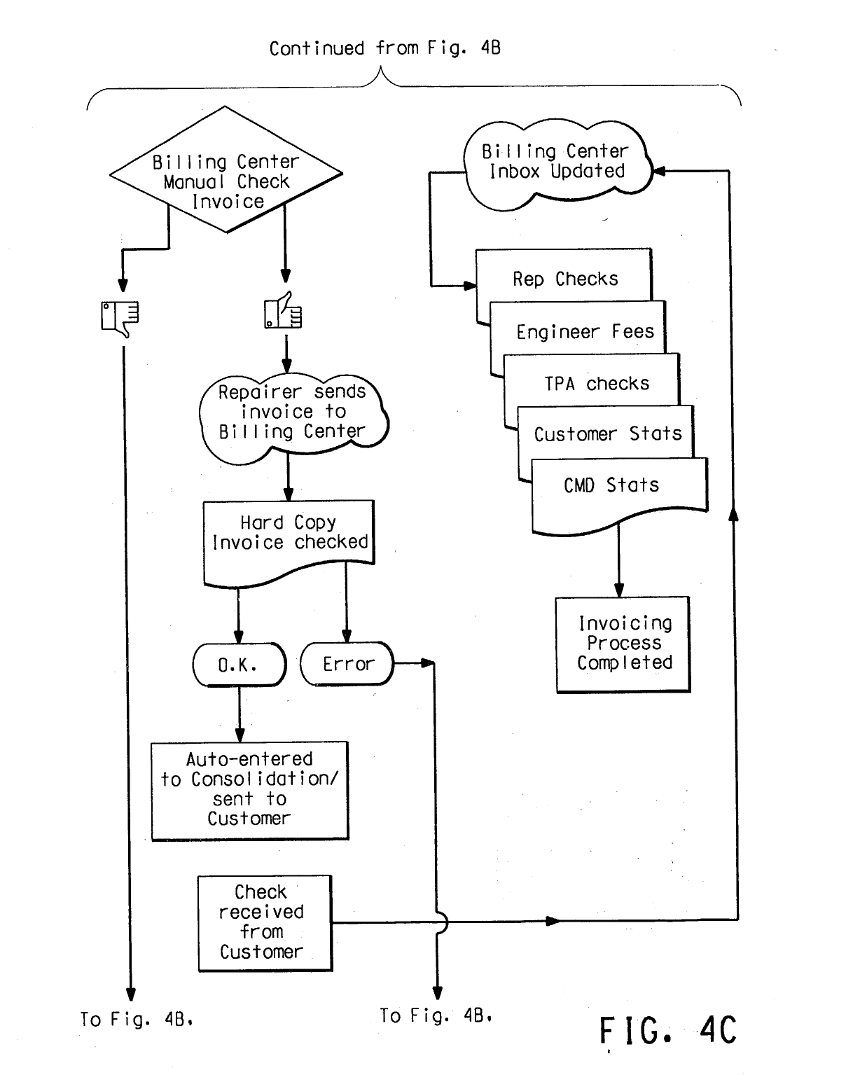

CMD can be created and implemented in a series of programs or initiatives. The first embodiment involves the implementation of a simple work assignment software that will include consolidated billing and payment options, as shown in FIGS. 4A, 4B and 4C. This first generation software also preferably has built-in auditing capability. This is in the form of self-audits (definable parameters), with the ability to send and receive open claims/repair orders between claims engineers and body shops.

The flow chart representing the first generation software also describe the software requirements for the first version of the supplier consolidated invoicing system. The system is designed to enhance and facilitate the information retrieval, functionality, e-commerce and communication between repair facilities, customers, insurers, engineers and shop networks.

Referring now to FIG. 3 or 4, the basic CMD process, as presently preferred, is shown. In the basic version, the auto insurance policy holder who is involved in an auto accident initiates the CMD process by placing a call to a Call Center to report the accident. This call may come directly to the insurance company Call Center or to CMD's Third Party Administrator (TPA) Call Center or may be received at the insurance company and then transferred to the TPA Call Center. This initiates the CMD process. All following steps of the CMD process are based on software and technology provided by the CMD process linked to a central CMD database (the “CMD Hub”). The Call Center gathers the required information from the policy holder as specified on an Incident Report Form and generates an incident report, which is sent to the CMD Hub, preferably maintained on a server accessible via the Internet. The Call Center also verifies policy coverage for that particular insured by checking with the CMD Hub which contains specific information about each policy holder, and is preferably populated and automatically updated by the insurance company. The Call Center also preferably sends notice to the insurance company of the claim, via Internet, email or fax. It is possible that this information will need to be exported back into the insurance company legacy system.

As shown in FIG. 3, if coverage is denied, the customer claim file is placed on hold and the customer is referred back to the insurance company. The insurance company is notified of the claim rejection preferably via web-enabled Intranet, email or fax. However, if coverage is approved, the CMD process continues and the Call Center performs a preliminary “triage” interview process, which preferably entails the use of the Payment Grid to determine preliminary paint and labor costs associated with the damage and assign the work to the appropriate shop. As used herein, “triage” means multiple choice questions with a selection of answers that will drive the next set of questions—this information will be provided by the TPA and/or the Insurance Carrier. The type of questions asked, include, for example, without limitation, extent of damage: drivable vs. non-drivable, identify panels damaged, airbags deployed, etc. When the answers to the triage questions are combined with the vehicle information from the policy, the CMD hub can then determine the allocation of the vehicle to the appropriate repair shop.

The information is then sent into the CMD Hub to also give a first assessment of the potential repair cost. This information is necessary for the insurance company, since the insurance company is required at that point to put that money in reserve and withdraw it from an interest bearing account. Depending on the quality of the initial assessment, the amount of economic loss to the insurance company can be minimized. The initial repair cost assessment preferably employs the use of a Preliminary Payment Grid, which is explained later in this description. The Call Center can then document the initial repair cost based on triage and the payment grid assignment and send it into the central CMD database. If the Payment Grid is not available, this step can be skipped.

The basic version of the CMD process also preferably includes a third party capture routine during the triage process, that allows the insurance company to direct the other party, if any, involved in the collision into the CMD managed care solution, so that CMD can manage the repair work of all parties involved. This also allows the insurance company to gain control of all the repair work costs. Accordingly, the Call Center preferably gathers information about Third Party involvement if applicable. The Call Center then contacts the Third Party to explain the benefits of using the CMD Network of repair facilities. A second claim is opened for Third Party if the referral is made and the Third Party claim follows the standard process as described above from this point. If the third party (non-fault) rejects repair by CMD, this preferably triggers documentation from the software to the third party and also notifies the insurance carrier that the third party had declined the offer of service.

Once all the initial claim data is gathered from the triage process, the claim data flows from the CMD Hub preferably into an autobody repair shop selection and allocation program, as shown in FIG. 3. The program is populated with network repair shop profiles from a shop accreditation process, which contain information on each repair shop such as, but not limited to, shop capacity, set up for light or heavy repairs, geographical location of shop, etc. The initial claim data is fed into the shop selection guide and a referral is made to a repair facility based on the vehicle damage and the repair facility specialization. The allocation program linked to the CMD Hub may either send an automatic allocation to the body shop that is also tied into the CMD network or the Call Center Personnel will have the option to make a manual override selection. Profile information for body shop includes but is not limited to the number of technician work hours, incoming work, work completed, etc. This information will be developed from the shop accreditation criteria.

Once a claim assignment is made, the Repair Facility receives the assignment information via Internet, e-mail, or Fax and must respond within preferably 20 minutes, although the time frame should have some flexibility for adjustment. If the assignment is not acknowledged, then an alert is sent, preferably electronically from the CMD Hub to the Call Center. An Assignment that is not picked up in the specified time frame will be routed by the Call Center to the next shop of the original list generated during triage. The Repair Facility receiving the assignment either accepts or rejects assignment. A rejected assignment will then be reassigned to next repair facility on the list.

Once a claim assignment is accepted that data preferably goes back into the CMD Hub. The repair shop then immediately contacts the vehicle owner/customer, via phone, fax, or e-mail with the details of the shop assignment. If customer objects to the selected shop, he must notify the Call Center via e-mail, fax or phone.

Upon receiving a rejection notice from the customer, the claim will be reassigned to another shop. The Call Center will be required to do the reallocation.

The Repair Facility makes arrangements to get the car to the shop including after hours retrieval. The Call Center will, however, be responsible to alert and dispatch recovery services (e.g., tow truck) via phone, fax, or e-mail after hours. The towing service will be required to notify the Call Center to confirm that contact has been made and retrieval is completed. Retrieval of non-drivable cars should be completed within 1 hour of assignment. The repair shop may provide a rental or courtesy car.

As shown in FIG. 3, preferably within four hours after the damaged vehicle arrives at the body shop, the body shop creates the triage “stage 2” assessment of the damage including parts required to repair the vehicle and digital images depicting the damage. The status of the repair process is preferably established at this point in the CMD central database (i.e., CMD Hub) and maintained by the body shop in the central database until the process is completed. At every major change in status, the customer might be updated via phone, fax, or e-mail.

The CMD System has the ability to import standard estimating software into the body shops and produce estimates, including labor time, rates, parts, paint and all other estimate data, in a single format. A detailed estimate should contain, along with all the other estimate data and information, a “replace” and/or “repair” parts listing, “strip and fit (tear-down)”, and paint in all cases. The possible total loss notification to the insurers' adjuster service based on pre-defined criteria should also be included in the system features. The system may also have the ability to cross reference Black Book (or some type of valuation tool) on a cost per transaction or subscription basis. Using standard estimating software, the CMD process allows the body shop to provide a detailed cost assessment of the repair work and labor costs. As shown in FIG. 4, the CMD software preferably has the appropriate delegation limits and parts selection requirements of the insurance carrier built in, so that the CMD process can automatically authorize the repair work or, in other instances, deploy an engineer or claims adjuster to the body shop for assessment and authorization. This information is then collected by the CMD Hub.

The repair parts listing is then sent to CMD Hub for parts procurement. This may include the ability to interface with an established on-line parts vendor. Parts are procured from a predefined vendor listing. The shop will nominate its preferred vendors. The system also is capable of supporting CMD preferred parts vendors. If the initial vendor cannot supply one or more of the parts ordered, a purchase order for the part(s) is to be returned and the system sends it to a secondary vendor. A shipping notice is sent to CMD including the cost of parts, shipment date, etc.

When the repair work is completed, the repair shop is responsible to notify the CMD Hub. The CMD Hub then issues a final invoice for the repair based on actual costs. The invoicing process, as shown in FIG. 4, will generate either an individual invoice or a consolidated invoice depending on the requirements of the insurance company. The CMD Hub will also handle all payments to parts suppliers, body shops, claims adjusters, insurance companies, TPA, CMD Hub Administrator, etc. All invoicing software will have the appropriate delegation limits and requirements of the insurance carrier built into the system, as well as automatic validation check points at appropriate steps within the process.

Referring back to FIG. 4, the Invoice then triggers a payment notice to the CMD Hub for the repair shop. The Shop Network Administration has access for reporting, tracking, and processing of payment to shop. The Customer then signs off on completed repairs. The signed form is then sent to the insurance company. A scanned digital image of the signed form should then be sent by the insurance company back into the CMD Hub and reside there permanently.

Finally, all claims and invoicing information will be gathered and sent by the CMD Hub in a consolidated format to Insurance Clients.

The CMD process is also capable of creating reports based on user-defined criteria at any point in the management process, including but not limited to:

Financial reporting

Incident reports by insurer, repair facility, and region

Cost comparison

Shop refusal of work

Damage-type report

Cycle time including failure to timely respond to assignment by repair facility

Consolidated invoice schedule

Repair status report

Confirmation and exception reports on parts procurement showing parts ordered, parts supplied, and parts returned

Exception report on parts when delivery time exceeds permitted limits

CSI (Customer Satisfaction Index)

Ability to interface with multiple CSI types

The CMD process software should also be configured to accept any future plug-ins and upgrades to the basic program, such as on-line car rentals, on-line parts procurement programs, and the like.

Second Embodiment—Enhanced CMD Process

Enhancements to the basic CMD process and related software include the addition of the Payment Grid and perhaps other plug-ins noted above. Also included are automatic allocations of work, the triage process and work rules. This electronic database eliminates significant inefficiency in the claims estimating negotiating of price interaction between the body shops and the claims adjusters. In the basic process a combination of manual and automated work are employed; whereas in the enhanced version, virtually all processes are fully automated.

Online parts procurement will also be added to the “electronic CMD hub” in this embodiment. This is aimed at creating a more efficient process and at controlling fraud in the industry. Both of these issues contribute significant cost to the process. On-line rental car hire can also be added to the enhanced version. The linking and audit processes will be unique for the CMD DRP (direct repair program) network.

The main component of the enhanced version of the CMD process includes the Payment Grid.

The parameters and general description for the “Grid” are as follows:

The grid addresses the majority of repairs and vehicle types, segmented by severity.

Vehicles fall into three basic damage categories:

Light

Medium

Heavy

Statistics show the greatest percentage of damaged vehicles fall into the light and medium categories. This is expected to be between 60-70% of the 85% of the repairable vehicle population. Data extraction and analysis will provide the exact numbers and will be updated based on experience and the data generated and stored in the CMD Hub. The payment grid will initially provide a solution for the less complex damage types with a great degree of accuracy and market acceptance. The remaining category of heavy damage may be addressed in a second stage.

Vehicles not initially included in the payment grid due to the lack of available data are:

Exotics and collector cars, e.g., Ferrari, Lamborghini, etc.

Classic vehicles

Custom vehicles

Vehicles more than 15 years old

Brand new models as released by motor manufacturers.

These make up approximately 15% of the accident population. New models will be addressed as data becomes available.

The Payment grid can be based on two types of data collection and analysis. They are categorizing the repair costs by non-specific vehicle types or specific vehicles types. There are advantages to each and challenges to each.

As to the Non-Specific Vehicle Type criteria, this requires developing a generic vehicle and parts list. From the vehicle perspective, all makes and models of cars will be categorized as either extra large, large, medium, small or extra small. This follows the fact that generally times are similar for repair operations of similar size vehicles, regardless of make or model. From a parts perspective, the list will include all possible fit options, allowing the repairer to select via triage stage 2, the appropriate category of damage from the grid. This will then produce a generic list of parts that the repairer would have the option of selecting as required for the repair.. The CMD Hub would then forward the generic list to the parts supplier to apply the model specific information (e.g., parts numbers and pricing).

As to the Vehicle Specific estimating criteria, this requires access to a pre-existing vehicle and parts specific database, e.g., ADP, Mitchell, etc. In this model, the CMD Hub would provide a different customer interface to the existing parts provider database. The specific parts order would then be sent to the supplier for pricing verification and availability.

For vehicles that don't qualify under a Payment Grid, a traditional estimating process is used to satisfy those claims. The traditional Estimating Process, which also may be used when the Payment Grid is unavailable, typically involves the following steps:

Determine value of loss

Settle on payment

Blueprint for repair (work process and parts required)

The estimating process is regarded by all participants in the claims process as the greatest single friction point between insurers and collision repairers. On average, it dramatically increases cost and cycle time. It also leads to artificial suppression of shop labor rates. Therefore it can be seen as a principal cause of mistrust between the parties.

CMD preferably eliminates the friction of the traditional estimating processing by redefining the methodology to ensure an efficient and optimized estimating process. It utilizes technology such as the Payment Grid to predetermine repair costs and create a blue print for the repair.

The enhanced version preferably also provides full automation of the CMD process through the CMD Hub, as shown in FIG. 3.

The invention will now be described by way of the Appendix which shows the presently preferred software requirements for the CMD process and the proposed CMD process model.

What is claimed is:

1. A method for managing an auto collision repair process, from an initial claim to final repair work, comprising:
providing a communication network between at least the insurance companies, third party assistance providers, and body shops;
sending an auto repair insurance claim to the communication network;
allocating repair work to the body shop that will perform the auto repair;
sending an auto repair insurance estimate through the communication network;
processing the insurance claim and generating data to satisfy claim;
invoicing the insurance company for the repair work completed;
sending the processed payment to the body shop that performed the auto repair work.

2. The method of claim 1 wherein the repair work is allocated to a body shop in a discrete body shop network.

3. The method of claim 1 wherein the auto repair estimate is generated by a Payment grid approach.

4. The method of claim 1 wherein the method is essentially fully automated.

5. A system for managing an auto collision repair process, from an initial claim to final repair work, comprising:
a remote computer for entering and processing data related to an auto repair insurance claim;
a network having a communication server capable of communicating with said remote computer;
an insurance claim datafile generated at said remote computer, wherein the entire datafile is transferable over the network;
a common user interface allowing access of the datafile by insurance companies, claims adjusters, third party assistance providers, body shops and possibly others;
software to process a claim to satisfy the claim and manage the repair work at a body shop.
